(19) United States
(12) Patent Application Publication
(10) Pub. No.: US 2003/0152836 A1
(43) Pub. Date: Aug. 14, 2003

(54) Nonaqueous electrolyte secondary cell

(75) Inventor: Taizo Sunano, Sumoto-shi (JP)

Correspondence Address: ARMSTRONG,WESTERMAN & HATTORI, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/352,026

(22) Filed: Jan. 28, 2003

(30) Foreign Application Priority Data
Jan. 31, 2002 (JP) 2002-24742

(51) Int. Cl. H01M 10/40; H01M 4/52; H01M 4/58; H01M 2/02

(52) U.S. Cl. 429/303; 429/223; 429/231.1; 429/231.3; 429/231.8; 429/176

(57) ABSTRACT

The present invention provides a nonaqueous electrolyte secondary cell using, as a cell casing, a film-like casing, in which pressure exerted by the structure of the casing is low, and a gel electrolyte including a polymer, a nonaqueous solvent, and an electrolyte salt. The cell inhibits an internal short-circuit caused by heat shrinkage of a separator and improves safety of the cell, by, for example, making the construction one in which the heat shrinkage rate in the width direction of the separator when heated to 130° C. is controlled to 50% or less and the weight percentage of the polymer in relation to the total weight of a component of the nonaqueous solvent with a boiling point of over 130° C. and the polymer is controlled to 5% or more

### BACKGROUND OF THE INVENTION

1. Field of the Invention

The present invention relates to a nonaqueous electrolyte secondary cell comprising: an electrode assembly including positive and negative electrodes, which intercalate and deintercalate lithium ions, and a separator disposed between the electrodes; a gel electrolyte comprising a polymer, a nonaqueous solvent, and an electrolyte salt; and a film-like casing enclosing the electrode assembly and the gel electrolyte.

2. Description of the Prior Art

With the recent development of mobile devices, there has been a demand for higher energy density in cells, which serve as the power source for those devices. In particular, for mobile phones and notebook computers, there has been a demand for lighter and thinner cells. In view of this, polymer cells using gel electrolytes are receiving attention. The polymer cell uses a gel electrolyte as the electrolyte, and thus has little leakage. In addition, since the polymer cell uses a soft casing such as an aluminum laminated film, there are advantages that the cell can be made lighter and thinner than conventional cells that use, as the casings, metal cans such as steel.

However, in contrast to cells using metal cans, laminated cells in which pressure exerted by the structure of the casing is little, are more greatly affected by, upon heating, heat shrinkage of the separator than the cells using metal cans. For this reason, the laminated cell easily causes an internal short-circuit caused by heat shrinkage of the separator, easily causing heat generation due to the internal short-circuit.

### SUMMARY OF THE INVENTION

In view of the foregoing and other problems in the prior art, it is an object of the present invention to provide a nonaqueous electrolyte secondary cell using a film-like casing that is capable of preventing, even when the cell is heated, heat generation due to an internal short-circuit caused by heat shrinkage of the separator and improving safety.

Under such an object, the present inventor has fully investigated the level of heat generated by an internal short-circuit caused by heat shrinkage of the separator. Consequently, the present inventor has discovered that the level of heat generated by an internal short-circuit caused by heat shrinkage of the separator was closely related to: the weight percentage of a polymer, which composes a gel electrolyte, in relation to the total weight of residual solvent left after heating the gel electrolyte to 130° C. and removing a component of nonaqueous solvent with a boiling point of 130° C. or less, and the polymer; and the shrinkage rate of the separator when heated to 130° C.

(i) A First Aspect of the Present Invention is Constructed as Follows

There is provided a nonaqueous electrolyte secondary cell comprising: an electrode assembly comprising a positive electrode, a negative electrode, and a separator disposed between the electrodes, the positive and negative electrodes intercalating and deintercalating lithium ions; a gel electrolyte comprising a polymer, a nonaqueous solvent, and an electrolyte salt; and a film-like casing enclosing the electrode assembly and the gel electrolyte, wherein: the positive electrode comprises at least one compound selected from the group consisting of lithium cobalt oxide and lithium nickel oxide; a heat shrinkage rate in a width direction of the separator when heated to 130° C. is 50% or less; and a weight percentage of the polymer in relation to a total weight of a component of the nonaqueous solvent with a boiling point of over 130° C. and the polymer is 5% or more.

In this construction, as the positive electrode, at least one compound selected from the group consisting of lithium cobalt oxide and lithium nickel oxide is used, and the heat shrinkage rate in the width direction of the separator when heated to 130° C. is controlled to 50% or less. In addition, the weight percentage of the polymer, which composes the gel electrolyte, in relation to the total weight of a component of the nonaqueous solvent with a boiling point of over 130° C. and the polymer is controlled to 5% or more.

In general, in a nonaqueous electrolyte cell using a film-like casing, when the cell temperature exceeds 130° C., the internal pressure of the cell exceeds the adhesive strength of the sealing parts of the casing, thereby destroying the hermeticity of the cell, rapidly evaporating off a component of the solvent with a boiling point of 130° C. or less. Consequently, the polymer concentration of the gel electrolyte, which comprises a polymer, a nonaqueous solvent, and an electrolyte salt, increases at a temperature of 130° C. In the above construction, the weight percentage of the polymer in relation to the total weight of a component of the nonaqueous solvent with a boiling point of over 130° C. and the polymer is controlled to 5% or more. With this construction, even in a cell in which a component of the solvent with a low boiling point of 130° C. or less is used and the viscosity of the gel electrolyte at a temperature of 130° C. or less is made small, the viscosity of the gel electrolyte increases at 130° C., which is the approximate temperature at which the hermeticity of the cell is destroyed, thereby increasing the adhesion. This allows the separator to be adhered more strongly to the positive and negative electrodes, restraining the heat shrinkage of the separator. Therefore, when the separator is such that the heat shrinkage rate in the width direction at 130° C. is controlled to 50% or less, an internal short-circuit caused by heat shrinkage of the separator can be sufficiently inhibited. In addition, even in cases where an internal short-circuit has occurred, the internal short-circuit level is low and thus the cell does not cause fire.

In the above construction, since the weight percentage of the polymer, which composes the gel electrolyte, in relation to the total weight of a component of the solvent with a boiling point of over 130° C. and the polymer is controlled to 5% or more, even in a system containing no components of the solvent with a low boiling point of 130° C. or less, an internal short-circuit caused by heat shrinkage of the separator can be inhibited by the adhesion of the gel electrolyte itself.

(ii) A Second Aspect of the Present Invention is Constructed as Follows

The nonaqueous electrolyte secondary cell of the first aspect of the present invention may be such that the heat shrinkage rate in the width direction of the separator when heated to 130° C. is 40% or less, and the weight percentage of the polymer in relation to the total weight is 10% or more.

With this construction, the viscosity of the gel electrolyte at a temperature of over 130° C. further increases. In addition, because the heat shrinkage rate in the width direction of the separator when heated to 130° C. is set to a lower level (40% or less) than that of the first aspect, the heat shrinkage of the separator can be more securely restrained. Thus, even when an internal short-circuit has occurred, the heat generated by the internal short-circuit (i.e., the temperature that increases by the internal short-circuit) can be controlled to 10° C. or less.

(iii) A Third Aspect of the Present Invention is Constructed as Follows

The nonaqueous electrolyte secondary cell of the first aspect of the present invention may be such that the separator is made of an olefin resin.

Olefin-based resin is electrically and chemically stable and inexpensive. Thus, with this construction, a cell with a long cell life and excellent safety can be provided at low cost.

(iv) A Fourth Aspect of the Present Invention is Constructed as Follows

The nonaqueous electrolyte secondary cell of the first aspect of the present invention may be such that the negative electrode comprises graphite as an active material.

Graphite has a large capacity for intercalating and deintercalating lithium ions. Hence, with this construction, a nonaqueous electrolyte secondary cell with high capacity and excellent safety can be realized.

(v) A Fifth Aspect of the Present Invention is Constructed as Follows

The nonaqueous electrolyte secondary cell of the first aspect of the present invention may be such that the polymer is formed by polymerizing a compound, the compound comprising at least one group selected from the group consisting of acryloyl and methacryloyl.

In a polymer formed by polymerizing a compound which comprises at least one group selected from the group consisting of acryloyl and methacryloyl, the electrical conductivity of lithium ions is excellent. Hence, with this construction, a cell with excellent safety and excellent discharge characteristics can be realized.

(vi) A Sixth Aspect of the Present Invention is Constructed as Follows

There is provided a nonaqueous electrolyte secondary cell comprising: an electrode assembly comprising a positive electrode, a negative electrode, and a separator disposed between the electrodes, the positive and negative electrodes intercalating and deintercalating lithium ions; a gel electrolyte comprising a polymer, a nonaqueous solvent, and an electrolyte salt; and a film-like casing enclosing the electrode assembly and the gel electrolyte, wherein: the positive electrode comprises lithium manganese oxide; a heat shrinkage rate in a width direction of the separator when heated to 130° C. is 60% or less; and a weight percentage of the polymer in relation to a total weight of a component of the nonaqueous solvent with a boiling point of over 130° C. and the polymer is 3% or more.

In nonaqueous electrolyte secondary cells, which are of interest to the present invention, the state of heat generation varies with the type of compounds contained in the positive electrode (hereinafter referred to as the positive electrode active material). When a cell uses lithium manganese oxide as the positive electrode active material, the cell is less likely to cause burns than a cell using, as the positive electrode active material, at least one compound selected from the group consisting of lithium cobalt oxide and lithium nickel oxide. Therefore, in a cell using lithium manganese oxide as the positive electrode, even when the range of the heat shrinkage rate of the separator is extended and the weight percentage of the polymer in relation to the total weight is reduced, the cell safety is less likely to be impaired than a cell using lithium cobalt oxide and the like. Thus, with the above construction, restrictions to ensure safety, i.e., restrictions on separator material and gel electrolyte composition can be eased.

(vii) A Seventh Aspect of the Present Invention is Constructed as Follows

The nonaqueous electrolyte secondary cell of the sixth aspect of the present invention may be such that the heat shrinkage rate in the width direction of the separator when heated to 130° C. is 50% or less, and the weight percentage of the polymer in relation to the total weight is 10% or more.

With this construction, the adhesion of the gel electrolyte when heated to 130° C. to the separator and the positive and negative electrodes further increases, whereby the heat shrinkage of the separator can be significantly restrained. Thus, even when an internal short-circuit has occurred, the heat generated by the internal short-circuit can be controlled to 10° C. or less. Accordingly, by the combination of the above function and effect, the safety of the nonaqueous electrolyte secondary cell is further improved.

(viii) An Eighth Aspect of the Present Invention is Constructed as Follows

The nonaqueous electrolyte secondary cell of the sixth aspect of the present invention may be such that the separator is made of an olefin resin.

(ix) A Ninth Aspect of the Present Invention is Constructed as Follows

The nonaqueous electrolyte secondary cell of the sixth aspect of the present invention may be such that the negative electrode comprises graphite as an active material.

(x) A Tenth Aspect of the Present Invention is Constructed as Follows

The nonaqueous electrolyte secondary cell of the sixth aspect of the present invention may be such that the polymer is formed by polymerizing a compound, the compound comprising at least one group selected from the group consisting of acryloyl and methacryloyl.

The technical significance of the eighth to tenth aspects of the present invention is the same as that of the third to fifth aspects of the present invention.

### BRIEF DESCRIPTION OF THE DRAWINGS

For a more complete understanding of the present invention, and the advantages thereof, reference is now made to the following descriptions taken in conjunction with the accompanying drawing, in which;

FIG. 1 is a front view of a nonaqueous electrolyte secondary cell according to the present invention;

FIG. 2 is a cross-sectional view taken along line A-A of FIG. 1; and

FIG. 3 is a perspective view of an electrode assembly utilized in a nonaqueous electrolyte secondary cell according to the present invention.

### DESCRIPTION OF THE PREFERRED EMBODIMENT

The embodiment of the present invention is explained below referring to the drawings.

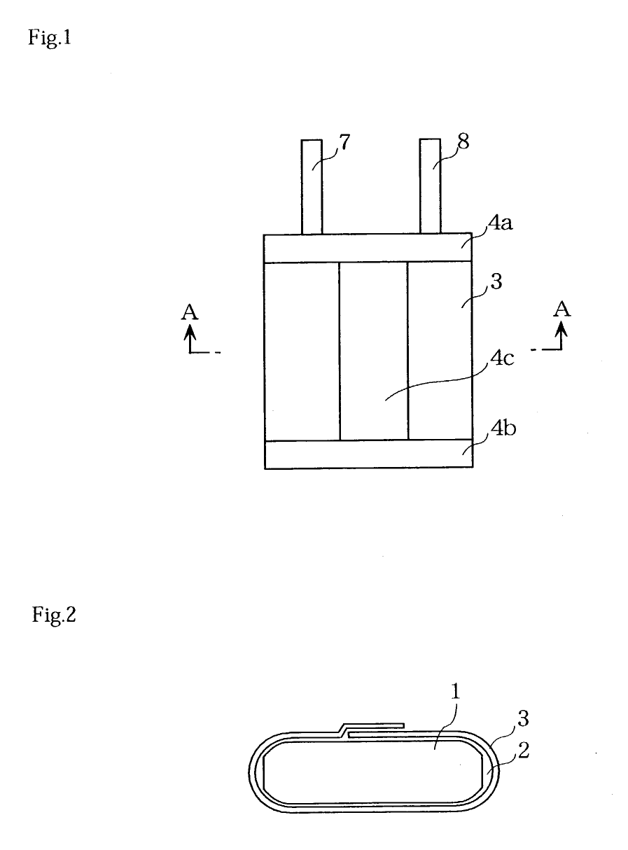

As shown in FIG. 2, a nonaqueous electrolyte secondary cell of the present invention has an electrode assembly 1 placed in an enclosure space 2. This enclosure space 2, as shown in FIG. 1, is formed by sealing the upper edge portion, lower edge portion, and central portion of a film-like casing 3 with sealing parts 4a, 4b, and 4c, respectively.

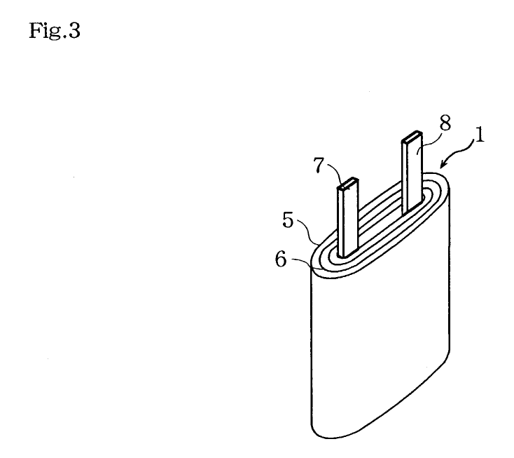

An electrolyte solution is poured in the enclosure space 2. The electrolyte solution is prepared by adding LiPF₆ and LiN(C₂F₅SO₂)₂ at a mole ratio of 5:95 to a mixed solvent comprising ethylene carbonate (EC) and diethyl carbonate (DEC) and mixing, and then dissolving the LiPF₆ and LiN(C₂F₅SO₂)₂ such that the total concentration is 1 M (mole/liter). As shown in FIG. 3, the electrode assembly 1 is prepared by winding a positive electrode 5, a negative electrode 6, and a separator for separating the electrodes (not shown in FIG. 3), into a flat spiral-shape.

The positive electrode 5 is connected to a positive electrode lead 7 comprising aluminum, and the negative electrode 6 is connected to a negative electrode lead 8 comprising copper, making the construction one in which chemical energy generated in the cell can be released as electrical energy outside the cell.

### EXAMPLE 1

Preparation of the Positive Electrode

A 90 weight % positive electrode active material comprising lithium cobalt oxide, a 5 weight % carbon-based conductivity enhancer comprising acetylene black, graphite, and the like, a 5 weight % binder comprising polyvinylidene fluoride (PVDF), and an organic solvent comprising N-methylpyrrolidone were mixed, thereby preparing an active material slurry.

Next, after the active material slurry was uniformly applied to both surfaces of a positive electrode substrate (thickness: 20 μm) comprising aluminum foil by using a doctor blade, this positive electrode substrate was dried in a dryer to eliminate the organic solvent that was necessary in the preparation of the slurry. Then, by rolling this electrode plate with a roller press, a positive electrode 5 having a thickness of 0.17 mm was prepared.

Preparation of the Negative Electrode

First, a negative electrode active material comprising natural graphite (d=0.336 nm), a binder comprising polyvinylidene fluoride (PVDF), and an organic solvent comprising N-methylpyrrolidone were mixed, thereby preparing an active material slurry. Next, after the active material slurry was uniformly applied to both surfaces of a negative electrode substrate (thickness: 20 μm) comprising copper foil by using a doctor blade, this negative electrode substrate was dried in a dryer to eliminate the organic solvent that was necessary in the preparation of the slurry. Then, by rolling this electrode plate with a roller press, a negative electrode 6 having a thickness of 0.14 mm was prepared.

Preparation of the Electrode Assembly

After a positive electrode lead 7 and a negative electrode lead 8 were fixed to the positive electrode and the negative electrode prepared as described above respectively, both electrodes were put together with a belt-shaped separator composed of a microporous film (thickness: 0.025 mm) comprising an olefin-based resin with a heat shrinkage rate in the width direction at 130° C. of 40%, disposed therebetween. At this time, the center lines in the direction of the widths of both the positive and negative electrodes were lined up. Then, the electrodes were wound with a winding machine and taped down the outermost coil, thereby preparing a flat spiral-shaped electrode assembly 1.

Preparation of the Pregel Solution

Next, an electrolyte solution was prepared by adding LiPF₆ and LiN(C₂F₅SO₂)₂, serving as electrolyte salts, at a mole ratio of 5:95 to a mixed solvent comprising ethylene carbonate (EC) and diethyl carbonate (DEC) at a weight ratio of 27.8:72.2 and mixing, and then dissolving the electrolyte salts such that the concentration was 1 M. A 97 weight % electrolyte solution was mixed with a 3 weight % pregel comprising polyethylene glycol diacrylate (the weight percentage of the polymer when heated to 130° C.=10%), thereby preparing a pregel solution.

Preparation of the Cell

First, as a film-like casing, a sheet of aluminum laminated film was prepared. This aluminum laminated film includes a metal layer comprising aluminum and a resin layer formed on both surfaces of the metal layer with an adhesive layer disposed therebetween Near edge portions of the resin layer of the aluminum laminated film were put together and then these portions were welded to form a sealing part 4c. Next, the electrode assembly 1 was enclosed in an enclosure space 2 of this tube-shaped aluminum laminated film. The electrode assembly 1 was arranged so that both leads 7 and 8 projected from one of the openings of the tube-shaped aluminum laminated film. Subsequently, the resin layer on the inner side of the aluminum laminated film at the opening from which the leads projected, was welded and sealed to form a sealing part 4a. Here, a high-frequency induction welding device was used.

After the pregel solution prepared above was poured in the casing through the opening of the aluminum laminated film on the opposite side from the sealing part 4a, the opening was then liquid tightly sealed to form a sealing part 4b. Finally, the aluminum laminated casing 3 was heated to gelatinize the pregel inside the aluminum laminated casing 3, thereby preparing a cell A1 of the present invention according to Example 1.

Measurement of Heat Shrinkage Rate of the Separator

The heat shrinkage rate of the separator was measured as follows. A separator material was cut to a size of 50 mm (length direction)×20 mm (width direction), and was then placed on a glass plate with the length direction of the separator being fixed with heat-resistant tape. The separator was heated to 130° C. with the width direction thereof being free, and the shrinkage rate was measured.

The weight percentage of the polymer when heated to 130° C. was calculated by the following equation, assuming that all the solvent components with a boiling point of 130° C. or less were volatilized.

100× weight of the polymer/(weight of the solvent component with a boiling point of over130° C.+weight of the polymer) (%)

### EXAMPLE 2

A cell A2 of the present invention according to Example 2 was prepared in the same way as Example 1, except that the weight ratio of the mixed solvent was changed such that EC:DEC=47.4:52.6 and the weight percentage of the polymer at 25° C. was changed to 5% (the weight percentage of the polymer when heated to 130° C.=10%).

### EXAMPLE 3

A cell A3 of the present invention according to Example 3 was prepared in the same way as Example 1, except that the weight ratio of the mixed solvent was changed such that EC:DEC=18.4:81.6 and the weight percentage of the polymer at 25° C. was changed to 2% (the weight percentage of the polymer when heated to 130° C.=10%)

### EXAMPLE 4

A cell A4 of the present invention according to Example 4 was prepared in the same way as Example 3, except that the weight ratio of the mixed solvent was changed such that EC:DEC=38.8:61.2 (the weight percentage of the polymer when heated to 130° C.=5%).

### EXAMPLE 5

A cell A5 of the present invention according to Example 5 was prepared in the same way as Example 1, except that dimethyl carbonate (DMC) was used for the mixed solvent in place of DEC.

### EXAMPLE 6

A cell A6 of the present invention according to Example 6 was prepared in the same way as Example 1, except that ethyl methyl carbonate (EMC) was used for the mixed solvent in place of DEC.

### EXAMPLE 7

A cell A6 of the present invention according to Example 7 was prepared in the same way as Example 1, except that the concentration of the electrolyte salt in the gel electrolyte was changed to 1.25 M.

### COMPARATIVE EXAMPLE 1

A comparative cell X1 according to Comparative Example 1 was prepared in the same way as Example 1, except for using a separator having a shrinkage rate when heated to 130° C. of 60%.

### COMPARATIVE EXAMPLE 2

A comparative cell X2 according to Comparative Example 2 was prepared in the same way as Example 2, except for using a separator having a shrinkage rate when heated to 130° C. of 60%.

### COMPARATIVE EXAMPLE 3

A comparative cell X3 according to Comparative Example 3 was prepared in the same way as Example 3, except that the weight ratio of the mixed solvent was changed such that EC:DEC=66.0:34.0 (the weight percentage of the polymer when heated to 130° C.=3%).

### COMPARATIVE EXAMPLE 4

A comparative cell X4 according to Comparative Example 4 was prepared in the same way as Example 5, except for using a separator having a shrinkage rate when heated to 130° C. of 60%.

### COMPARATIVE EXAMPLE 5

A comparative cell X5 according to Comparative Example 5 was prepared in the same way as Example 6, except for using a separator having a shrinkage rate when heated to 130° C. of 60%.

### COMPARATIVE EXAMPLE 6

A comparative cell X6 according to Comparative Example 6 was prepared in the same way as Example 7, except for using a separator having a shrinkage rate when heated to 130° C. of 60%.

Heating Test

A heating test was conducted on the cells prepared as described above.

Under the heating test conditions where the cells in the charged state were heated to 150° C. at a heating-up rate of 5° C./min, and then held for 3 hours at 150° C., the presence of an internal short-circuit, the presence of burns, and the cell temperature in the case where the cell did not cause burns, were investigated. The test results were evaluated as follows. The letter “a” denotes a cell that generated heat of 10° C. or less, the letter “b” denotes a cell that generated heat of over 10° C. but did not cause burns, and the letter “c” denotes a cell that caused burns. In addition, for the presence of an internal short-circuit, the cell voltage was measured every five seconds during the heating test, and the one that produced a voltage change of 0.2 V or more was considered to have an internal short-circuit.

Under the conditions of constant current-constant voltage charging, the cells were charged at a constant current of 500 mA until a voltage of 4.2 V was attained, and thereafter charging was switched to constant voltage at 4.2 V, the charging being complete after a total of 3 hours.

The constructions and results of the heating tests for the cells A1 to A7 of the present invention and the comparative cells X1 to X6 are given in Table 1.

TABLE 1

| | | | | | Shrinkage | |
|---|---|---|---|---|---|---|
| | Electrolyte | Weight | | Weight | rate of | |
| | salt | percentage | | percentage | separator | Heating |
| | concentration | of polymer | | of polymer | at 130° C. | test |
| Cell | (mol/l) | at 25° C. | EC:DEC:DMC:EMC | at 130° C. | (%) | results |
| A1 | 1 | 3 | 27.8:72.2:0:0 | 10 | 40 | a |
| A2 | 1 | 5 | 47.4:52.6:0:0 | 10 | 40 | a |
| A3 | 1 | 2 | 18.4:81.6:0:0 | 10 | 40 | a |
| A4 | 1 | 2 | 38.8:61.2:0:0 | 5 | 40 | b |
| A5 | 1 | 3 | 27.8:0:72.2:0 | 10 | 40 | a |
| A6 | 1 | 3 | 27.8:0:0:72.2 | 10 | 40 | a |
| A7 | 1.25 | 3 | 27.8:72.2:0:0 | 10 | 40 | a |
| X1 | 1 | 3 | 27.8:72.2:0:0 | 10 | 60 | c |
| X2 | 1 | 5 | 47.4:52.6:0:0 | 10 | 60 | c |
| X3 | 1 | 2 | 66.0:34.0:0:0 | 3 | 40 | c |
| X4 | 1 | 3 | 27:8:0:72.2:0 | 10 | 60 | c |
| X5 | 1 | 3 | 27.8:0:0:72.2 | 10 | 60 | c |
| X6 | 1.25 | 3 | 27.8:72.2:0:0 | 10 | 60 | c |

a: No internal short-circuit, or even when an internal short-circuit has occurred, the heat generated is 10° C. or less.

b: The heat generated due to an internal short-circuit exceeds 10° C. but the cell does not cause burns.

c: An internal short-circuit has occurred and the cell has caused burns.

From the results for the cells A1, X1, A2, and X2, in which between the cells A1 and X1 and between the cells A2 and X2 the weight percentage of the polymer at 25° C. is different, the weight percentage of the polymer when heated to 130° C. is the same, and the shrinkage rate of the separator is different, it was found that the presence of an internal short-circuit and the level of heat generated by an internal short-circuit are determined by the shrinkage rate of the separator when heated to 130° C., but not by the weight percentage of the polymer at 25° C.

From the results for the cells A3, A4, and X3, which have the same weight percentage of the polymer at 25° C., the same shrinkage rate of the separator when heated to 130° C., and different weight percentages of the polymer when heated to 130° C., it was found that the presence of an internal short-circuit and the level of heat generated by an internal short-circuit are determined by the weight percentage of the polymer when heated to 130° C., but not by the weight percentage of the polymer at 25° C.

From the results for the cells A1, X1, A5, X4, A6, and X5, in which between the cells A1 and X1, between the cells A5 and X4, and between the cells A6 and X5 the solvent component with a boiling point of 130° C. or less in the mixed solvent is different and the shrinkage rate of the separator is different, it was found that the presence of an internal short-circuit and the level of heat generated by an internal short-circuit are not affected by the solvent to be used.

Furthermore, from the results for the cells A1, X1, A7, and X6, in which between the cells A1 and X1 and between the cells A7 and X6 the concentration of electrolyte salt in the electrolyte solution is different and the shrinkage rate of the separator is different, it was found that the presence of an internal short-circuit and the level of heat generated by an internal short-circuit are not affected by the concentration of the electrolyte salt to be used.

In all the cells that were denoted by the letters “b” and “c” in Table 1, degradation of the hermeticity of the cells was confirmed.

From the above results, it was found that determining factors for the occurrence of an internal short-circuit and the level of heat generated by an internal short-circuit are the weight percentage of the polymer when heated to 130° C. and the shrinkage rate of the separator when heated to 130° C. In other words, it was found that they are determined by the balance between the shrinkage of the separator at high temperatures and the adhesion of the gel electrolyte at high temperatures.

The optimum balance between the shrinkage of the separator at high temperatures and the adhesion of the gel electrolyte at high temperatures was determined in Examples 8 and 9 below.

### EXAMPLE 8

Various cells were prepared in the same way as Example 1, except that as the positive electrode, lithium cobalt oxide was used and the weight percentage of the polymer when heated to 130° C. and the heat shrinkage rate of the separator when heated to 130° C., shown in Table 2 below, were changed variously.

### EXAMPLE 9

Various cells were prepared in the same way as Example 1, except that as the positive electrode active material, lithium manganese oxide was used and the weight percentage of the polymer when heated to 130° C. and the heat shrinkage rate of the separator when heated to 130° C., shown in Table 3 below, were changed variously.

The heating test was performed on the cells prepared as described above under the same conditions as those for Example 1 and the like.

The results of the heating tests performed on the various cells, which used lithium cobalt oxide as the positive electrode and had various weight percentages of the polymer when heated to 130° C. and various heat shrinking rates of the separator when heated to 130° C., are given in Table 2.

TABLE 2
Heating test results

| Shrinkage rate | | | | | | |
|---|---|---|---|---|---|---|
| of separator at | Weight percentage of polymer at 130° C. | | | | | |
| 130° C. (%) | 3 | 5 | 10 | 20 | 30 | 40 |
| 10 | a | a | a | a | a | a |
| 20 | c | a | a | a | a | a |
| 30 | c | b | a | a | a | a |
| 40 | c | b | a | a | a | a |
| 50 | c | b | b | a | a | a |
| 60 | c | c | c | c | c | a |

a: No internal short-circuit, or even when an internal short-circuit has occurred, the heat generated is 10° C. or less.

b: An internal short-circuit has occurred and the heat generated by the internal short-circuit exceeds 10° C. but the cell does not cause burns.

c: An internal short-circuit has occurred and the cell has caused burns.

The results of the heating tests performed on the various cells, which used lithium manganese oxide as the positive electrode and had various weight percentages of the polymer when heated to 130° C. and various heat shrinkage rates of the separator when heated to 130° C., are given in Table 3.

TABLE 3
Heating test results

| Shrinkage rate | | | | | | |
|---|---|---|---|---|---|---|
| of separator at | Weight percentage of polymer at 130° C. | | | | | |
| 130° C. (%) | 3 | 5 | 10 | 20 | 30 | 40 |
| 10 | a | a | a | a | a | a |
| 20 | b | a | a | a | a | a |
| 30 | b | a | a | a | a | a |
| 40 | b | a | a | a | a | a |
| 50 | b | b | a | a | a | a |
| 60 | b | b | b | b | b | a |

a: No internal short-circuit, or even when an internal short-circuit has occurred, the heat generated is 10° C. or less.

b: An internal short-circuit has occurred and the heat generated by the short-circuit exceeds 10° C. but the cell does not cause burns.

The relationship between the weight percentage of the polymer at 25° C. and the weight percentage of the polymer when heated to 130° C., which is found by the ratio of the weight of solvent component that does not volatilize at 130° C. to the weight of all the solvent components, is shown in Table 4.

TABLE 4

| | (Solvent component | |
|---|---|---|
| | that does not volatilize | |
| Weight percentage of | at 130° C.)/(All the | Weight percentage of |
| polymer at 25° C. | solvent components) | polymer at 130° C. |
| 2 | 0.660 | 3 |
| 2 | 0.388 | 5 |
| 3 | 0.588 | 5 |
| 2 | 0.184 | 10 |
| 3 | 0.278 | 10 |
| 5 | 0.474 | 10 |
| 5 | 0.211 | 20 |
| 10 | 0.444 | 20 |
| 10 | 0.260 | 30 |
| 15 | 0.412 | 30 |
| 10 | 0.167 | 40 |
| 15 | 0.265 | 40 |

From the results shown in Table 2, it was found that in the case where lithium cobalt oxide is used as the positive electrode, when the cell is such that the shrinkage rate of the separator when heated to 130° C. is 50% or less and the weight percentage of the polymer when heated to 130° C. is 5% or more, an internal short-circuit does not occur upon heating, or even when an internal short-circuit has occurred, the cell does not cause burns resulting from heat generated by the internal short-circuit.

In addition, from the results shown in Table 2, it was found that when the cell is such that the shrinkage rate of the separator when heated to 130° C. is 40% or less and the weight percentage of the polymer when heated to 130° C. is 10% or more, an internal short-circuit does not occur upon heating, or even when an internal short-circuit has occurred, the heat generated by the internal short-circuit can be controlled to a temperature of 10° C. or less.

Even when the cell is such that the shrinkage rate of the separator when heated to 130° C. is 10% or less and the weight percentage of the polymer at 130° C. is 3% or more or such that the shrinkage rate of the separator when heated to 130° C. is 60% or less and the weight percentage of the polymer at 130° C. is 40% or more, an internal short-circuit does not occur upon heating, or even when an internal short-circuit has occurred, the cell has the effect of controlling the heat generated by the internal short-circuit, to a temperature of 10° C. or less From the results shown in Table 3, it was found that in the case where lithium manganese oxide is used as the positive electrode, when the cell is such that the shrinkage rate of the separator is 60% or less and the weight percentage of the polymer when heated to 130° C. is 3% or more, an internal short-circuit does not occur upon heating, or even when an internal short-circuit has occurred, the cell does not cause burns Further, from the results shown in Table 3, it was found that when the cell is such that the shrinkage rate of the separator is 50% or less and the weight percentage of the polymer when heated to 130° C. is 10% or more, an internal short-circuit does not occur upon heating, or even when an internal short-circuit has occurred, the heat generated by the internal short-circuit can be controlled to a temperature of 10° C. or less

Supplementary Remarks

For the negative electrode material, in addition to natural graphite, carbon black, coke, glassy carbon, carbon fiber, the baked form of these substances, and the like, can be suitably used.

Solvents are not limited to the ethylene carbonate (EC) and diethyl carbonate (DEC) used above, and it is possible to use mixed solvents in which two or three or more types of solvents selected from those with a comparatively high relative permittivity such as propylene carbonate, vinylene carbonate, and γ-butyrolactone, and those with a low viscosity and low boiling point such as dimethyl carbonate, ethyl methyl carbonate, tetrahydrofuran, 1,2-dimethoxyethane, 1,3-dioxolane, 2-methoxytetrahydrofuran, and diethyl ether, are mixed.

Electrolyte salts are not limited to LiPF₆ and LiN(C₂F₅SO₂)₂ used above, and it is possible to use electrolyte salts such as LiN(CF₃SO₂)₂, LiClO₄, and LiBF₄.

The active material slurry can be applied using a die coater instead of using a doctor blade. It is also possible to use an active material paste instead of an active material slurry and apply it by roller coating. In addition, even in cases where aluminum mesh is used as the positive electrode substrate, the positive electrode can be prepared in the same way as that described above.

Even in cases where lithium nickel oxide is used as the positive electrode active material, similar effects as when using lithium cobalt oxide can be achieved. In addition, even in cases where the lithium cobalt oxide or lithium nickel oxide contains different metallic elements in its crystal lattice, similar effects can be achieved. Furthermore, even in cases where lithium manganese oxide contains different metallic elements in its crystal lattice, similar effects can be achieved.

In the present embodiment, lithium cobalt oxide and lithium manganese oxide were used alone, but even in the case of using a mixture of two or three compounds selected from the group consisting of lithium cobalt oxide, lithium nickel oxide, and lithium manganese oxide, similar effects can be achieved.

The polymer used in the present invention is not limited to the one formed by polymerizing the polyethylene glycol diacrylate used above, and it is possible to use polymers formed by polymerizing polyethylene glycol dimethacrylate, methoxy polyethylene glycol monoacrylate, and the like, and also possible to use polymers formed by polymerizing mixtures of the above-described compounds.

What is claimed is:

1. A nonaqueous electrolyte secondary cell comprising:
an electrode assembly comprising a positive electrode, a negative electrode, and a separator disposed between the electrodes, the positive and negative electrodes intercalating and deintercalating lithium ions;
a gel electrolyte comprising a polymer, a nonaqueous solvent, and an electrolyte salt; and
a film-like casing enclosing the electrode assembly and the gel electrolyte, wherein:
the positive electrode comprises at least one compound selected from the group consisting of lithium cobalt oxide and lithium nickel oxide;
a heat shrinkage rate in a width direction of the separator when heated to 130° C. is 50% or less; and
a weight percentage of the polymer in relation to a total weight of a component of the nonaqueous solvent with a boiling point of over 130° C. and the polymer is 5% or more.

2. The nonaqueous electrolyte secondary cell according to claim 1, wherein:
the heat shrinkage rate in the width direction of the separator when heated to 130° C. is 40% or less; and
the weight percentage of the polymer in relation to the total weight is 10% or more.

3. The nonaqueous electrolyte secondary cell according to claim 1, wherein the separator is made of an olefin resin.

4. The nonaqueous electrolyte secondary cell according to claim 1, wherein the negative electrode comprises graphite as an active material.

5. The nonaqueous electrolyte secondary cell according to claim 1, wherein the polymer is formed by polymerizing a compound, the compound comprising at least one group selected from the group consisting of acryloyl and methacryloyl.

6. A nonaqueous electrolyte secondary cell comprising:
an electrode assembly comprising a positive electrode, a negative electrode, and a separator disposed between the electrodes, the positive and negative electrodes intercalating and deintercalating lithium ions;
a gel electrolyte comprising a polymer, a nonaqueous solvent, and an electrolyte salt; and
a film-like casing enclosing the electrode assembly and the gel electrolyte, wherein:
the positive electrode comprises lithium manganese oxide;
a heat shrinkage rate in a width direction of the separator when heated to 130° C. is 60% or less; and
a weight percentage of the polymer in relation to a total weight of a component of the nonaqueous solvent with a boiling point of over 130° C. and the polymer is 3% or more.

7. The nonaqueous electrolyte secondary cell according to claim 6, wherein:
the heat shrinkage rate in the width direction of the separator when heated to 130° C. is 50% or less; and
the weight percentage of the polymer in relation to the total weight is 10% or more.

8. The nonaqueous electrolyte secondary cell according to claim 6, wherein the separator is made of an olefin resin.

9. The nonaqueous electrolyte secondary cell according to claim 6, wherein the negative electrode comprises graphite as an active material.

10. The nonaqueous electrolyte secondary cell according to claim 6, wherein the polymer is formed by polymerizing a compound, the compound comprising at least one group selected from the group consisting of acryloyl and methacryloyl.
